(19) United States
(12) Patent Application Publication
(10) Pub. No.: US 2022/0320937 A1
(43) Pub. Date: Oct. 6, 2022

(54) BUSBAR UNIT, STATOR, AND METHOD FOR MANUFACTURING BUSBAR UNIT

(71) Applicant: NIDEC CORPORATION, Kyoto (JP)

(72) Inventors: Hibiki TAKADA, Kyoto (JP); Takahiro HIWA, Kyoto (JP); Hisashi FUJIHARA, Kyoto (JP); Tatsuhiko MIZUTANI, Kyoto (JP)

(21) Appl. No.: 17/616,188

(22) PCT Filed: Jun. 1, 2020
(86) PCT No.: PCT/JP2020/021519

§ 371 Date: Dec. 3, 2021

(30) Foreign Application Priority Data
Jun. 6, 2019 (JP) 2019-106506

(51) Int. Cl. H02K 3/28; H02K 1/16; H02K 3/12; H02K 15/04

(52) U.S. Cl. CPC H02K 3/28; H02K 1/16; H02K 3/12; H02K 15/0435

(57) ABSTRACT

A busbar unit includes: three-phase busbars connected to three-phase coils; and three-phase external terminals that are members different from the three-phase busbars, the three-phase external terminals being connected to the three-phase busbars and electrically connected to a power supply source. Each of the three-phase external terminals includes: a terminal body portion; a busbar-side connection portion connected to a busbar of one phase from among the three-phase busbars; and a power-supply-source-side connection portion electrically connected to the power supply source. At least two terminals among the three-phase external terminals are different in length of a conduction path through which a current flows between the busbar-side connection portion and the power-supply-source-side connection portion in the terminal body portion.

### CROSS-REFERENCE TO RELATED APPLICATIONS

This is the U.S. national stage of application No. PCT/JP2020/021519, filed on Jun. 1, 2020, and priority under 35 U.S.C. § 119(a) and 35 U.S.C. § 365(b) is claimed from Japanese Patent Application No. 2019-106506, filed on Jun. 6, 2019.

### FIELD OF THE INVENTION

The present invention relates to a busbar unit, a stator, and a method for manufacturing a busbar unit. The present invention claims priority based on Japanese Patent Application No. 2019-106506 filed in Japan on Jun. 6, 2019, the contents of which are incorporated herein by reference.

### BACKGROUND

A stator is known that uses a plurality of busbars corresponding to respective phases as connection members for electrically connecting multi-phase coils and a power supply source. There is known a power feeding unit including three power feeders corresponding to a U-phase, a V-phase, and a W-phase, respectively, each of the power feeders including a busbar as the connection member. Each of the power feeders includes a coil-side terminal connected to a coil, an external-side terminal connected to a terminal block included in an external power circuit, and a power feeder body that couples the coil-side terminal and the external-side terminal. In the power feeding unit, the external-side terminals of the three power feeders are arranged in an order same as the order of the phases in the terminal block. In each of the power feeders, the power feeder body, the coil-side terminal, and the external-side terminal are integrally formed as a single member.

The arrangement of output terminals of respective phases of a power supply source may vary depending on the configuration of the power supply source. In this case, in a motor including the power feeder in which the power feeder body, the coil-side terminal, and the external-side terminal are integrally formed as a single member, when the arrangement order of the phases in the terminal block included in the external power circuit is changed, it is necessary to change the configuration of the motor such as changing the configuration of the power feeding unit. The external-side terminal corresponds to an external terminal, the power feeder corresponds to a busbar, and the external power circuit corresponds to a power supply source.

### SUMMARY

An exemplary busbar unit according to the present invention includes: multi-phase busbars connected to multi-phase coils wound around a stator core; and multiple terminals that are members different from the multi-phase busbars, the multiple terminals being connected to the multi-phase busbars and electrically connected to a power supply source. Each of the multiple terminals includes a terminal body portion, a busbar-side connection portion located at one end of the terminal body portion and connected to a busbar of one phase from among the multi-phase busbars, and a power-supply-source-side connection portion located at another end of the terminal body portion and electrically connected to the power supply source. At least two terminals among the multiple terminals are different in length of a conduction path through which a current flows between the busbar-side connection portion and the power-supply-source-side connection portion in the terminal body portion.

An exemplary stator according to the present invention includes: the busbar unit described above; the stator core; and multi-phase coils wound around the stator core and connected to the multi-phase busbars of the busbar unit.

An exemplary method for manufacturing a busbar unit according to the present invention is a method for manufacturing a busbar unit which includes multi-phase busbars respectively connected to multi-phase coils wound around a stator core, and multiple terminals respectively connected to the multi-phase busbars and electrically connected to a power supply source. The multiple terminals include at least two terminals that are different in length of a conduction path through which a current flows between a busbar-side connection portion connected to a busbar of one phase among the multi-phase busbars and a power-supply-source-side connection portion electrically connected to the power supply source. The method for manufacturing the busbar unit includes: a terminal molding step for molding the multiple terminals with resin and forming a recess in a side where the busbar-side connection portions are located to expose tips of the busbar-side connection portions; a connection step for connecting the multi-phase busbars to the busbar-side connection portions of the multiple terminals in the recess; and a connection portion molding step for molding the inside of the recess with resin while the busbar-side connection portions are located in the recess.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram illustrating a schematic configuration of a motor according to a first embodiment;

FIG. 2 is a perspective view of a stator;

FIG. 3 is a perspective view of the stator from which a busbar holder and an external terminal holder are removed;

FIG. 4 is a perspective view schematically illustrating a positional relationship between a stator core and coils;

FIG. 5 is a perspective view of a busbar unit;

FIG. 6 is a perspective view of the busbar unit from which the busbar holder and the external terminal holder are removed;

FIG. 7A is a perspective view illustrating a schematic configuration of a U-phase busbar;

FIG. 7B is a perspective view illustrating a schematic configuration of a V-phase busbar;

FIG. 7C is a perspective view illustrating a schematic configuration of a W-phase busbar;

FIG. 7D is a perspective view illustrating a schematic configuration of a neutral point busbar;

FIG. 8 is a perspective view illustrating an arrangement of the four busbars attached to a coil end portion;

FIG. 9 is a diagram, corresponding to FIG. 2, illustrating a stator according to a second embodiment;

FIG. 10 is a diagram, corresponding to FIG. 3, illustrating the stator according to the second embodiment;

FIG. 11 is a diagram, corresponding to FIG. 8, illustrating a busbar according to a second embodiment; and

FIG. 12 is a perspective view of external terminals and connection portions between the external terminals and the busbars.

### DETAILED DESCRIPTION

Embodiments of the present invention will be described below in detail with reference to the drawings. The same or corresponding parts in the drawings are denoted by the same reference numerals, and the description thereof will not be repeated. The constituent members in the drawings are not limited to have the dimensions and the dimensional ratios illustrated in the drawings.

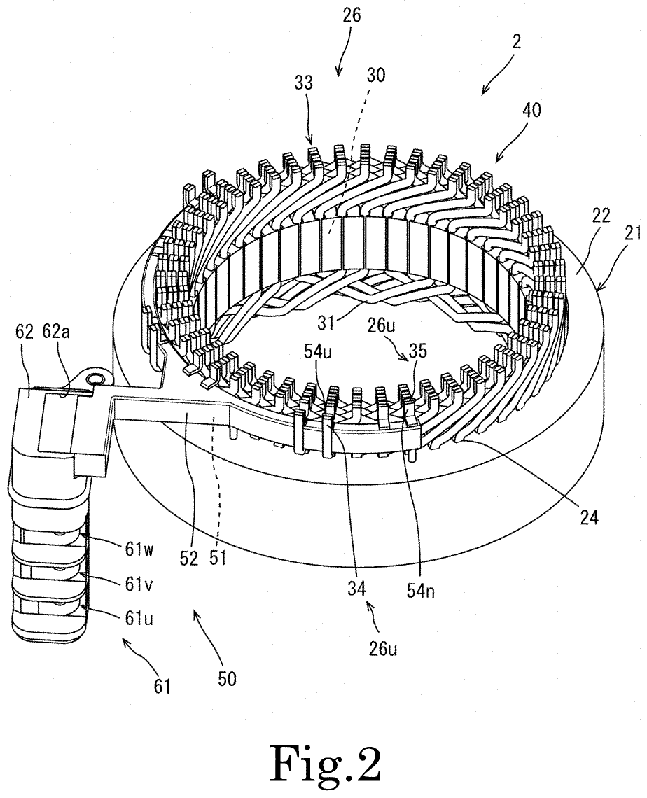

In the following description, a direction parallel to a central axis of a stator is referred to as an “axial direction”, a direction perpendicular to the central axis is referred to by the term “radial direction” or “radially”, and a direction along an arc around the central axis is referred to as a “circumferential direction”. In addition, regarding the axial direction, a side where a busbar is located with respect to the stator is referred to as a “first side”, and a side opposite to the side where the busbar is located with respect to the stator is referred to as a “second side”. That is, in the present specification, an upper side is the “first side”, and a lower side is the “second side” in FIG. 2. However, there is no intention to limit the direction at the time of using a motor according to the present invention by the definitions of the directions.

Further, in the following description, expressions such as “fixed”, “connected”, and “attached” (hereinafter, fixed, etc.) are used not only when the members are directly fixed to each other, but also when the members are fixed via another member. That is, in the following description, the expression such as “fixed” includes the meaning indicating that the members are directly fixed and the members are indirectly fixed.

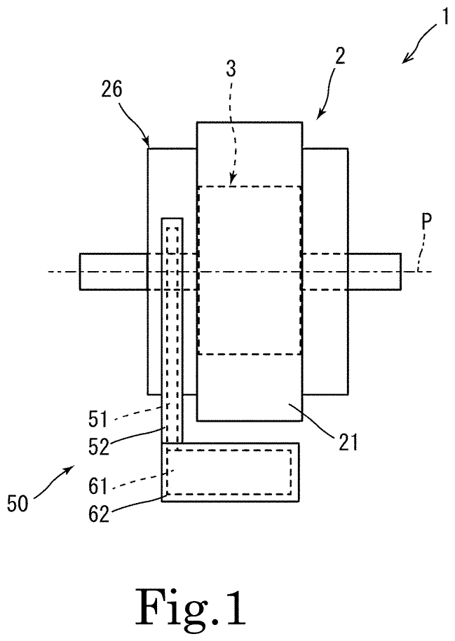

FIG. 1 shows a schematic configuration of a motor 1 according to the first embodiment of the present invention. The motor 1 includes a stator 2 and a rotor 3. The rotor 3 rotates about a central axis P with respect to the stator 2. That is, the motor 1 has the stator 2 and the rotor 3 that is rotatable with respect to the stator 2.

In the present embodiment, the motor 1 is a so-called inner rotor type motor in which the rotor 3 is located so as to be rotatable about the central axis P in the tubular stator 2. The rotor 3 includes a plurality of magnets arranged in the circumferential direction around the central axis P. Since the configuration of the rotor 3 is similar to that of a typical rotor, the detailed description of the rotor 3 will be omitted.

The stator 2 includes a stator core 21, coils 26, and a busbar unit 50. In FIG. 1, the coils 26 are illustrated in a simplified manner for the sake of description. Power is supplied to the coils 26 via busbars 51 and external terminals 61 of the busbar unit 50 described later. In the present embodiment, the coils 26 include three-phase coils 26u, 26v, and 26w as described later.

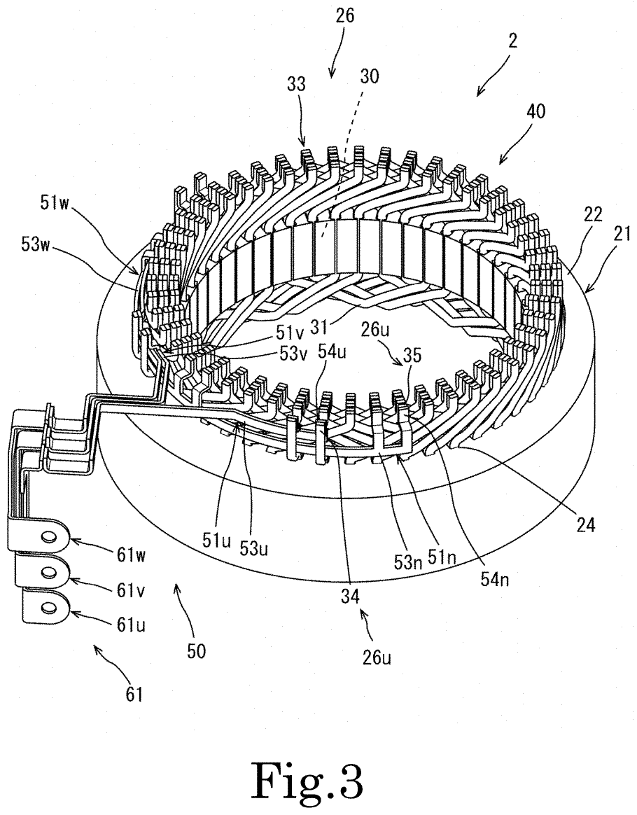

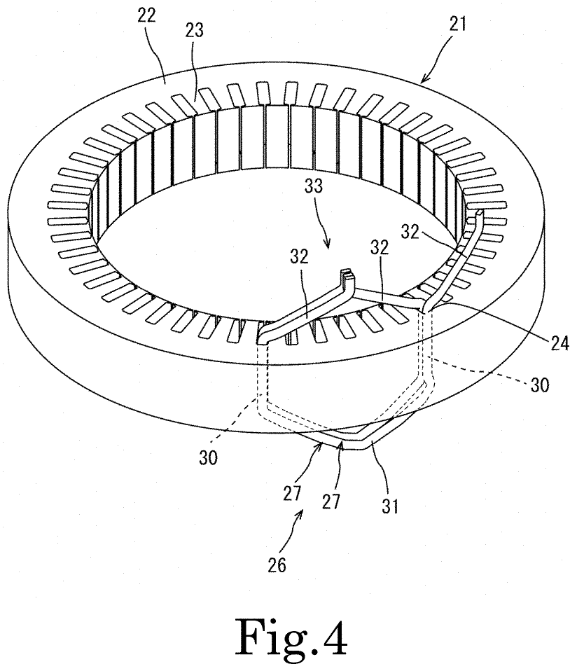

FIG. 2 is a perspective view of the stator 2 of the motor 1 according to the present embodiment. FIG. 3 is a diagram illustrating a state in which a busbar holder 52 and an external terminal holder 62 of the busbar unit 50 are removed from the stator 2 illustrated in FIG. 2. FIG. 4 is a perspective view schematically illustrating an example of a positional relationship between the stator core 21 and the coils 26. FIG. 4 only illustrates a part of the coils 26 located in slots 24 of the stator core 21 for the sake of description.

The stator core 21 has a cylindrical shape extending in the axial direction. The stator core 21 is obtained by stacking a plurality of electromagnetic steel sheets formed in a predetermined shape in the thickness direction.

The stator core 21 includes a cylindrical yoke 22, a plurality of teeth 23 (see FIG. 4) extending inward from the yoke 22 in the radial direction, and the slots 24. In the present embodiment, the stator core 21 is a cylindrical round core. The yoke 22 and the plurality of teeth 23 are integrally formed as a single member. The stator core 21 may be, for example, a split core or a straight core.

As illustrated in FIG. 4, the plurality of teeth 23 is arranged at equal intervals in the circumferential direction. Each of the teeth 23 extends from one end to the other end of the stator core 21 in the axial direction. The slot 24 is located between adjacent teeth 23 among the plurality of teeth 23. The slot 24 is a groove extending in the axial direction in the stator core 21. The slot 24 extends along the central axis P. The stator core 21 has a plurality of slots 24 arranged in the circumferential direction on the inner peripheral surface. As will be described later, a plurality of coils 26 is inserted into the plurality of slots 24.

In the present embodiment, the coils 26 include a U-phase coil 26u, a V-phase coil 26v, and a W-phase coil 26w. The coils 26 are wound around the plurality of teeth 23 in a distributed winding, and are Y-connected by the four busbars 51. In the present embodiment, the coils 26 include two sets of U-phase coils 26u, V-phase coils 26v, and W-phase coils 26w. In the following description and drawings, when it is necessary to distinguish the phases of the respective components, u, v, w, and n indicating the U phase, the V phase, the W phase, and the neutral point are added to the end of the reference numerals of the respective components.

In each of the U-phase coil 26u, the V-phase coil 26v, and the W-phase coil 26w, multiple segment coils 27 are connected in series. Each segment coil 27 has a rectangular cross-sectional shape and is constituted by a bent rectangular wire. Note that the cross-sectional shape of the segment coil 27 may not be rectangular as long as it is made of a material having high rigidity.

As illustrated in FIGS. 2 to 4, each segment coil 27 includes a pair of linear slot accommodation portions 30 located in the slots 24, a segment coil connection portion 31 connecting the pair of slot accommodation portions 30, and a pair of segment coil end portions 32 which are ends of the segment coil 27. The plurality of segment coils may include a segment coil having a linear slot accommodation portion and segment coil end portions located at both ends of the slot accommodation portion.

The slot accommodation portions 30 of the plurality of segment coils 27 are accommodated in the slots 24 while being overlapped in the radial direction. The segment coil connection portions 31 of the plurality of segment coils 27 are positioned on the second side in the axial direction with respect to the stator core 21 in a state where the slot accommodation portions 30 are accommodated in the slots 24 of the stator core 21. The slot accommodation portion 30 constitutes slot accommodation portion of the coil 26. The segment coil connection portion 31 constitutes a first coil connection portion of the coil 26. In the following description, the slot accommodation portion of the coil 26 is denoted by the same reference numeral as the slot accommodation portion 30 of the segment coil 27, and the first coil connection portion of the coil 26 is also denoted by the same reference numeral as the segment coil connection portion 31 of the segment coil 27.

In the plurality of segment coils 27, the tip of one of the pair of segment coil end portions 32 in each segment coil 27 and the tip of one of the pair of segment coil end portions 32 in the other segment coil 27 are connected by welding or the like in a state where the slot accommodation portions 30 are accommodated in the slots 24. That is, the pair of segment coil end portions 32 in each segment coil 27 is connected to the segment coil end portions 32 of the different segment coil 27. Thus, the plurality of segment coils 27 is connected in series. The U-phase coil 26u, the V-phase coil 26v, and the W-phase coil 26w are each constituted by the plurality of segment coils 27 connected in series in this manner.

In the present embodiment, the connected segment coil end portions 32 constitute a second coil connection portion 33 that connects the pair of slot accommodation portions 30 in each of the U-phase coil 26u, the V-phase coil 26v, and the W-phase coil 26w. The second coil connection portion 33 is located on the first side in the axial direction with respect to the stator core 21.

Each of the U-phase coil 26u, the V-phase coil 26v, and the W-phase coil 26w has a pair of segment coil end portions 32 that is not connected to the segment coil end portions 32 of the other segment coil 27. The segment coil end portions 32 that are not connected to the other segment coil end portions 32 in the U-phase coil 26u, the V-phase coil 26v, and the W-phase coil 26w are coil ends of the U-phase coil 26u, the V-phase coil 26v, and the W-phase coil 26w. The coil ends of the U-phase coil 26u, the V-phase coil 26v, and the W-phase coil 26w are located at one end and the other end of the coil of each phase. The coil ends of the U-phase coil 26u, the V-phase coil 26v, and the W-phase coil 26w protrude to the first side in the axial direction of the stator core 21.

Hereinafter, for the sake of description, the ends of the coil located at both ends of each of the U-phase coil 26u, the V-phase coil 26v, and the W-phase coil 26w are referred to as a first coil end 34 and a second coil end 35, respectively.

That is, the coils 26 of the present embodiment include the U-phase coil 26u, the V-phase coil 26v, and the W-phase coil 26w, and the coils 26 include the plurality of slot accommodation portions 30 positioned in the plurality of slots, the plurality of second coil connection portions 33 positioned on the first side in the axial direction with respect to the stator core 21 and connecting the slot accommodation portions 30, the plurality of first coil connection portions 31 positioned on the second side in the axial direction with respect to the stator core 21 and connecting the slot accommodation portions 30, and the first coil ends 34 and the second coil ends 35 positioned at the ends of the coils 26, extending from the slot accommodation portions 30, and protruding to the first side in the axial direction of the stator core 21.

With this configuration, the coil end portion 40 that includes the plurality of second coil connection portions 33 protruding from the stator core 21 to the first side in the axial direction is formed on the first side in the axial direction with respect to the stator core 21. A coil end portion that includes the plurality of first coil connection portions 31 protruding from the stator core 21 to the second side is formed on the second side in the axial direction with respect to the stator core 21.

In the present embodiment, all the second coil connection portions 33 are positioned on the first side in the axial direction (upper side in FIG. 2) with respect to the stator core 21, and all the first coil connection portions 31 are positioned on the second side in the axial direction (lower side in FIG. 2) with respect to the stator core 21. In addition, all the first coil ends 34 and all the second coil ends 35 are located on the first side in the axial direction where the second coil connection portions 33 are located.

The first coil end 34 and the second coil end 35 of each of the U-phase coil 26u, the V-phase coil 26v, and the W-phase coil 26w extend from the slot accommodation portions 30 located on the radially outermost side of the slots 24 and protrude from the stator core 21. The first coil end 34 and the second coil end 35 are the segment coil end portions 32 of the segment coil 27 located on the radially outermost side of the slots 24 in the U-phase coil 26u, the V-phase coil 26v, and the W-phase coil 26w. In the present embodiment, the coils 26 include two sets of U-phase coils 26u, V-phase coils 26v, and W-phase coils 26w. Therefore, six first coil ends 34 and six second coil ends 35 are located on the first side in the axial direction with respect to the stator core 21.

In the present embodiment, each of the first coil ends 34 and the second coil ends 35 are the segment coil end portions 32 of the segment coils 27 located on the radially outermost side of the slots 24. However, the first coil ends and the second coil ends may be segment coil end portions of segment coils located at positions other than the above positions.

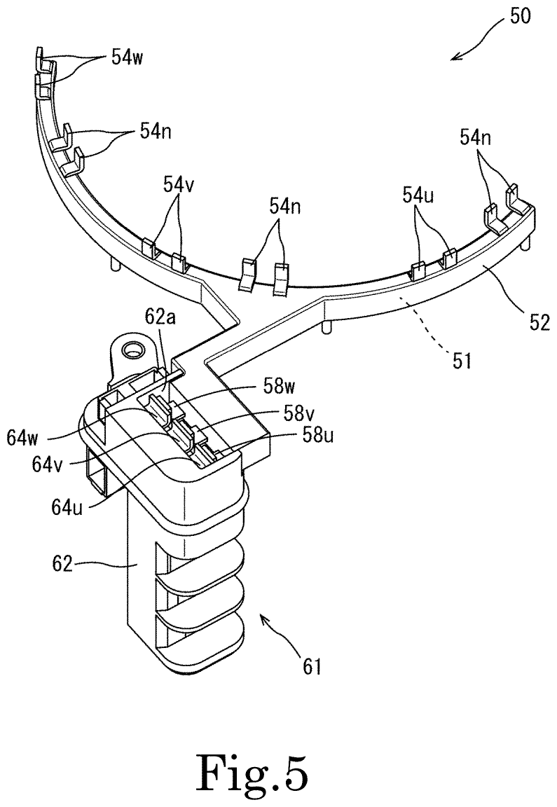

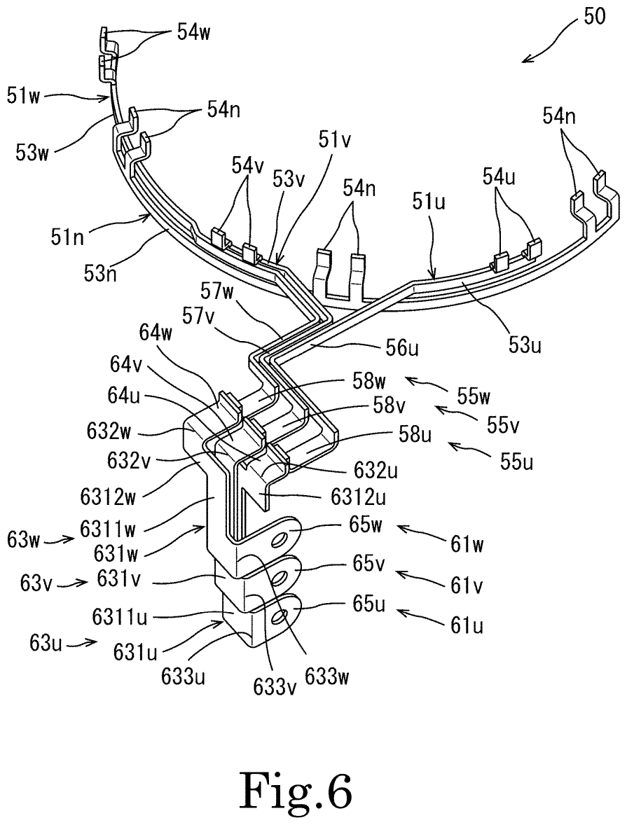

FIG. 5 is a perspective view of the busbar unit 50. As illustrated in FIG. 5, the busbar unit 50 includes the busbars 51, the busbar holder 52, the external terminals 61, and the external terminal holder 62. FIG. 6 is a perspective view of the busbar unit 50 from which the busbar holder 52 and the external terminal holder 62 are removed. The external terminals 61 correspond to terminals.

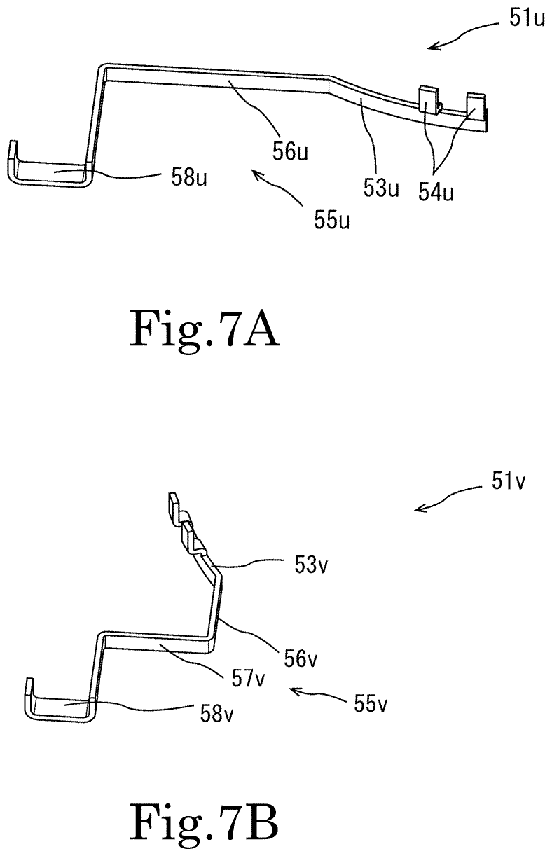

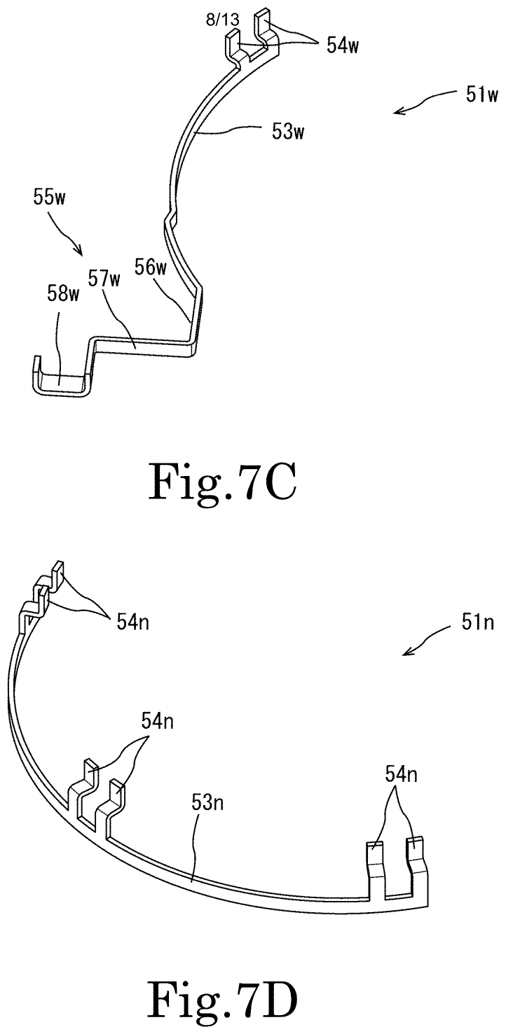

The busbars 51 include a U-phase busbar 51u, a V-phase busbar 51v, a W-phase busbar 51w, and a neutral point busbar 51n. FIG. 7A illustrates a schematic configuration of the U-phase busbar 51u, FIG. 7B illustrates a schematic configuration of the V-phase busbar 51v, FIG. 7C illustrates a schematic configuration of the W-phase busbar 51w, and FIG. 7D illustrates a schematic configuration of the neutral point busbar 51n. Each of the U-phase busbar 51u, the V-phase busbar 51v, the W-phase busbar 51w, and the neutral point busbar 51n is a plate-shaped member. The thickness direction of each of the U-phase busbar 51u, the V-phase busbar 51v, the W-phase busbar 51w, and the neutral point busbar 51n coincides with the radial direction of the stator core 21.

As illustrated in FIG. 7A, the U-phase busbar 51u includes a U-phase busbar body portion 53u, two U-phase busbar connection portions 54u, and a U-phase external terminal connection portion 55u. The U-phase busbar body portion 53u, the two U-phase busbar connection portions 54u, and the U-phase external terminal connection portion 55u are integrally formed as a single member.

As illustrated in FIG. 7B, the V-phase busbar 51v includes a V-phase busbar body portion 53v, two V-phase busbar connection portions 54v, and a V-phase external terminal connection portion 55v. The V-phase busbar body portion 53v, the two V-phase busbar connection portions 54v, and the V-phase external terminal connection portion 55v are integrally formed as a single member.

As illustrated in FIG. 7C, the W-phase busbar 51w includes a W-phase busbar body portion 53w, two W-phase busbar connection portions 54w, and a W-phase external terminal connection portion 55w. The W-phase busbar body portion 53w, the two W-phase busbar connection portions 54w, and the W-phase external terminal connection portion 55w are integrally formed as a single member.

As illustrated in FIG. 7D, the neutral point busbar 51n includes a neutral point busbar body portion 53n and six neutral point busbar connection portions 54n. The neutral point busbar body portion 53n and the six neutral point busbar connection portions 54n are integrally formed as a single member.

Each of the U-phase busbar body portion 53u, the V-phase busbar body portion 53v, and the W-phase busbar body portion 53w has an arc shape along the outer periphery of the coil end portion 40 when viewed in the axial direction. Each of the U-phase busbar body portion 53u, the V-phase busbar body portion 53v, and the W-phase busbar body portion 53w is positioned to overlap the first coil end 34 of the coil 26 of each phase when viewed in the radial direction of the stator core 21, and extends in the circumferential direction of the stator core 21.

Specifically, the U-phase busbar body portion 53u is positioned to overlap the first coil ends 34 of the two U-phase coils 26u when viewed in the radial direction of the stator core 21, and extends in the circumferential direction of the stator core 21. The V-phase busbar body portion 53v is positioned to overlap the first coil ends 34 of the two V-phase coils 26v when viewed in the radial direction of the stator core 21, and extends in the circumferential direction of the stator core 21. The W-phase busbar body portion 53w of the W-phase busbar 51w is positioned to overlap the first coil ends 34 of the two W-phase coils 26w when viewed in the radial direction of the stator core 21, and extends in the circumferential direction of the stator core 21.

The neutral point busbar body portion 53n of the neutral point busbar 51n has an arc shape along the outer periphery of the coil end portion 40 when viewed in the axial direction. The neutral point busbar body portion 53n is positioned to overlap the second coil ends 35 of the two U-phase coils 26u, two V-phase coils 26v, and two W-phase coils 26w when viewed in the radial direction of the stator core 21, and extends in the circumferential direction of the stator core 21. In the present embodiment, the neutral point busbar body portion 53n is longer in the circumferential direction than the U-phase busbar body portion 53u, the V-phase busbar body portion 53v, and the W-phase busbar body portion 53w.

The U-phase external terminal connection portion 55u extends outward from one end of the U-phase busbar body portion 53u in the radial direction and is connected to the external terminal 61. The U-phase external terminal connection portion 55u includes a U-phase extension portion 56u extending outward of the stator core 21 in the radial direction from one end of the U-phase busbar body portion 53u, and a U-phase connection end portion 58u located at the tip of the U-phase extension portion 56u and connected to the external terminal 61.

The V-phase external terminal connection portion 55v extends outward from one end of the V-phase busbar body portion 53v in the radial direction and is connected to the external terminal 61. The V-phase external terminal connection portion 55v includes: a V-phase first extension portion 56v extending outward of the stator core 21 in the radial direction from one end of the V-phase busbar body portion 53v; a V-phase second extension portion 57v that is perpendicular to the V-phase first extension portion 56v and that extends toward the external terminal 61; and a V-phase connection end portion 58v located at the tip of the V-phase second extension portion 57v and connected to the external terminal 61.

The W-phase external terminal connection portion 55w extends outward from one end of the W-phase busbar body portion 53w in the radial direction and is connected to the external terminal 61. The W-phase external terminal connection portion 55w includes: a W-phase first extension portion 56w extending outward of the stator core 21 in the radial direction from one end of the W-phase busbar body portion 53w; a W-phase second extension portion 57w that is perpendicular to the W-phase first extension portion 56w and that extends toward the external terminal 61; and a W-phase connection end portion 58w located at the tip of the W-phase second extension portion 57w and connected to the external terminal 61.

The detailed configuration of the external terminal 61 will be described later.

The two U-phase busbar connection portions 54u are arranged in the circumferential direction and extend to the first side in the axial direction of the stator core 21 from the other end of the U-phase busbar body portion 53uThe two U-phase busbar connection portions 54u are connected to the first coil ends 34 of the U-phase coils 26u.

The two V-phase busbar connection portions 54v are arranged in the circumferential direction and extend to the first side in the axial direction of the stator core 21 from the other end of the V-phase busbar body portion 53vThe two V-phase busbar connection portions 54v are connected to the first coil ends 34 of the V-phase coils 26v.

The two W-phase busbar connection portions 54w are arranged in the circumferential direction and extend to the first side in the axial direction of the stator core 21 from the other end of the W-phase busbar body portion 53w.

The two W-phase busbar connection portions 54w are connected to the first coil ends 34 of the W-phase coils 26w.

The six neutral point busbar connection portions 54n are arranged in pairs in the circumferential direction, extend to the first side in the axial direction of the stator core 21 from the neutral point busbar body portion 53nand are connected to the second coil ends 35 of two sets of coils of respective phases.

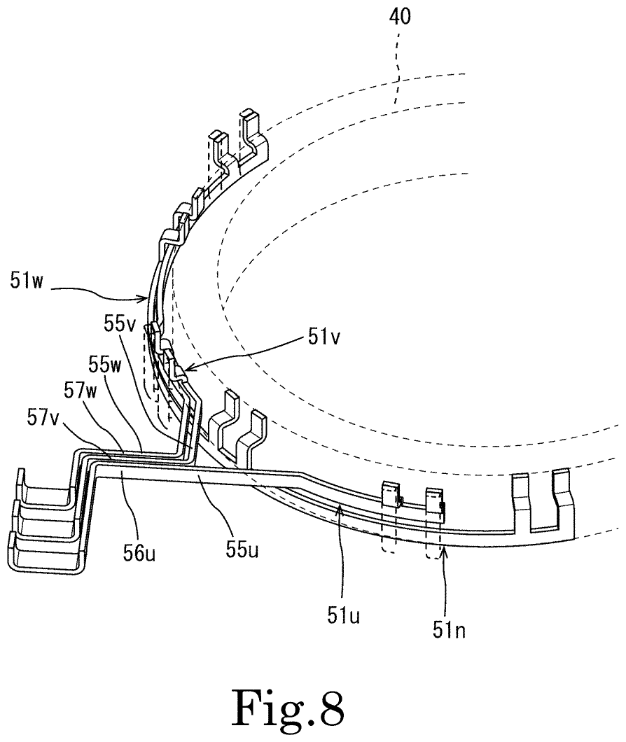

The U-phase busbar 51u, the V-phase busbar 51v, the W-phase busbar 51w, and the neutral point busbar 51n are located on the outer peripheral side of the coil end portion 40 in the radial direction in a state of partially overlapping each other in the radial direction or the axial direction. FIG. 8 illustrates an example of the arrangement of the U-phase busbar 51u, the V-phase busbar 51v, the W-phase busbar 51w, and the neutral point busbar 51n with respect to the coil end portion 40.

As illustrated in FIG. 6, the U-phase busbar body portion 53u is located on a first side in the circumferential direction of the stator core 21 with respect to the U-phase external terminal connection portion 55u when viewed in the axial direction. The W-phase busbar body portion 53w is located on a second side in the circumferential direction of the stator core 21 with respect to the W-phase external terminal connection portion 55w when viewed in the axial direction. The V-phase busbar body portion 53v is located on the second side in the circumferential direction of the stator core 21 with respect to the V-phase external terminal connection portion 55v when viewed in the axial direction, and the V-phase busbar body portion 53v overlaps a part of the W-phase busbar body portion 53w when viewed in the radial direction of the stator core 21.

The neutral point busbar body portion 53n is located on the second side in the axial direction with respect to the U-phase busbar body portion 53u, the V-phase busbar body portion 53v, and the W-phase busbar body portion 53w, and a part of the neutral point busbar body portion 53n overlaps the U-phase busbar body portion 53u, the V-phase busbar body portion 53v, and the W-phase busbar body portion 53w when viewed in the axial direction.

As described above, the thickness direction of each of the U-phase busbar 51u, the V-phase busbar 51v, and the W-phase busbar 51w coincides with the radial direction of the stator core 21. That is, the thickness direction of each of the U-phase external terminal connection portion 55uthe V-phase external terminal connection portion 55vand the W-phase external terminal connection portion 55w extending outward in the radial direction from the U-phase busbar body portion 53u, the V-phase busbar body portion 53v, and the W-phase busbar body portion 53w coincides with the direction perpendicular to the axial direction.

The U-phase extension portion 56u of the U-phase external terminal connection portion 55u, the V-phase second extension portion 57v of the V-phase external terminal connection portion 55v, and the W-phase second extension portion 57w of the W-phase external terminal connection portion 55w extend outward in the radial direction while overlapping each other in the thickness direction, and bent in the thickness direction while overlapping each other in the thickness direction.

The U-phase connection end portion 58u, the V-phase connection end portion 58v, and the W-phase connection end portion 58w extend outward in the radial direction from the tips of the U-phase extension portion 56u, the V-phase second extension portion 57v, and the W-phase second extension portion 57w, respectively. The thickness direction of each of the U-phase connection end portion 58u, the V-phase connection end portion 58v, and the W-phase connection end portion 58w coincides with the axial direction of the stator core 21.

The U-phase extension portion 56u, the V-phase second extension portion 57v, and the W-phase second extension portion 57w are different from each other in length from the positions where they are bent to the tips. As a result, the U-phase connection end portion 58u, the V-phase connection end portion 58v, and the W-phase connection end portion 58w extending from the tips of the U-phase extension portion 56u, the V-phase second extension portion 57v, and the W-phase second extension portion 57w are arranged in line without overlapping each other when viewed in the axial direction.

The U-phase busbar 51u, the V-phase busbar 51v, the W-phase busbar 51w, and the neutral point busbar 51n are molded with resin except for the tips of the U-phase busbar connection portion 54u, the V-phase busbar connection portion 54v, the W-phase busbar connection portion 54w, and the neutral point busbar connection portion 54n and the tips of the U-phase connection end portion 58u, the V-phase connection end portion 58v, and the W-phase connection end portion 58w (see FIG. 5). In the present specification, a resin portion covering the four busbars 51 is referred to as the busbar holder 52.

In the present embodiment, the U-phase coils 26u, the V-phase coils 26v, and the W-phase coils 26w are Y-connected by the U-phase busbar 51u, the V-phase busbar 51v, the W-phase busbar 51w, and the neutral point busbar 51n.

Specifically, the first coil ends 34 of the U-phase coils 26u are connected to the U-phase busbar connection portions 54u. The first coil ends 34 of the V-phase coils 26v are connected to the V-phase busbar connection portions 54v of the V-phase busbar 51v. The first coil ends 34 of the W-phase coils 26w are connected to the W-phase busbar connection portions 54w of the W-phase busbar 51w. Further, the six second coil ends 35 of the U-phase coils 26u, the V-phase coils 26v, and the W-phase coils 26w are connected to the neutral point busbar 51n.

Thus, the stator 2 can be obtained in which the U-phase coils 26u, the V-phase coils 26v, and the W-phase coils 26w wound around the stator core 21 are Y-connected by the U-phase busbar 51u, the V-phase busbar 51v, the W-phase busbar 51w, and the neutral point busbar 51n.

As illustrated in FIGS. 5 and 6, the external terminals 61 include a U-phase external terminal 61u, a V-phase external terminal 61v, and a W-phase external terminal 61w. The U-phase external terminal 61u, the V-phase external terminal 61v, and the W-phase external terminal 61w are plate-shaped members and molded with resin.

The U-phase external terminal 61u includes a U-phase terminal body portion 63u, a U-phase busbar-side connection portion 64u located at one end of the U-phase terminal body portion 63u, and a U-phase power-supply-source-side connection portion 65u located at another end of the U-phase terminal body portion 63u. The U-phase terminal body portion 63u, the U-phase busbar-side connection portion 64u, and the U-phase power-supply-source-side connection portion 65u are integrally formed as a single member.

The U-phase terminal body portion 63u includes a U-phase terminal flat portion 631u, a U-phase busbar-side bent portion 632u, and a U-phase power-supply-source-side bent portion 633u. The U-phase terminal flat portion 631u corresponds to a flat portion, and the U-phase busbar-side bent portion 632u corresponds to a bent portion.

The U-phase terminal flat portion 631u has a rectangular U-phase first flat portion 6311u extending in the axial direction, and a U-phase second flat portion 6312u extending in the width direction of the U-phase first flat portion 6311u from the U-phase first flat portion 6311u on the first side in the axial direction. Hereinafter, the direction in which the U-phase first flat portion 6311u extends is referred to as an extension direction of the U-phase terminal body portion 63u.

The U-phase busbar-side bent portion 632u is a portion bent in a direction perpendicular to the U-phase second flat portion 6312u from the first side of the U-phase second flat portion 6312u in the axial direction on the first side in the axial direction. The U-phase power-supply-source-side bent portion 633u is a portion bent in a direction perpendicular to the U-phase first flat portion 6311u from one end in the width direction of the U-phase first flat portion 6311u on the second side in the axial direction.

The U-phase busbar-side connection portion 64u extends in the thickness direction of the U-phase terminal body portion 63u from the U-phase busbar-side bent portion 632u and is connected to the U-phase connection end portion 58u of the U-phase busbar 51u. The U-phase power-supply-source-side connection portion 65u extends in the thickness direction of the U-phase terminal body portion 63u from the U-phase power-supply-source-side bent portion 633u and is connected to the power supply source.

The V-phase external terminal 61v includes a V-phase terminal body portion 63v, a V-phase busbar-side connection portion 64v located at one end of the V-phase terminal body portion 63v, and a V-phase power-supply-source-side connection portion 65v located at another end of the V-phase terminal body portion 63v. The V-phase terminal body portion 63v, the V-phase busbar-side connection portion 64v, and the V-phase power-supply-source-side connection portion 65v are integrally formed as a single member.

The V-phase terminal body portion 63v includes a V-phase terminal flat portion 631v, a V-phase busbar-side bent portion 632v, and a V-phase power-supply-source-side bent portion 633v. The V-phase terminal flat portion 631v corresponds to the flat portion, and the V-phase busbar-side bent portion 632v corresponds to the bent portion.

The V-phase terminal flat portion 631v has a rectangular shape extending in the axial direction. In the axial direction, the length of the V-phase terminal flat portion 631v is shorter than the length of the U-phase first flat portion 6311u. Hereinafter, the direction in which the V-phase terminal flat portion 631v extends is referred to as an extension direction of the V-phase terminal body portion 63v.

The V-phase busbar-side bent portion 632v is a portion bent in a direction perpendicular to the V-phase terminal flat portion 631v from the first side of the V-phase terminal flat portion 631v in the axial direction on the first side in the axial direction. The V-phase power-supply-source-side bent portion 633v is a portion bent in a direction perpendicular to the V-phase terminal flat portion 631v from one end of the V-phase terminal flat portion 631v in the width direction on the second side in the axial direction.

The V-phase busbar-side connection portion 64v extends in the thickness direction of the V-phase terminal body portion 63v from the V-phase busbar-side bent portion 632v and is connected to the V-phase connection end portion 58v of the V-phase busbar 51v. The V-phase power-supply-source-side connection portion 65v extends in the thickness direction of the V-phase terminal body portion 63v from the V-phase power-supply-source-side bent portion 633v and is connected to the power supply source.

The W-phase external terminal 61w includes a W-phase terminal body portion 63w, a W-phase busbar-side connection portion 64w located at one end of the W-phase terminal body portion 63w, and a W-phase power-supply-source-side connection portion 65w located at another end of the W-phase terminal body portion 63w. The W-phase terminal body portion 63w, the W-phase busbar-side connection portion 64w, and the W-phase power-supply-source-side connection portion 65w are integrally formed as a single member.

The W-phase terminal body portion 63w includes a W-phase terminal flat portion 631w, a W-phase busbar-side bent portion 632w, and a W-phase power-supply-source-side bent portion 633w. The W-phase terminal flat portion 631w corresponds to the flat portion, and the W-phase busbar-side bent portion 632w corresponds to the bent portion.

The W-phase terminal flat portion 631w has a rectangular W-phase first flat portion 6311w extending in the axial direction, and a W-phase second flat portion 6312w extending from the W-phase first flat portion 6311w in a direction opposite to the direction in which the U-phase second flat portion 6312u extends on the first side in the axial direction. In the axial direction, the length of the W-phase first flat portion 6311w is shorter than the lengths of the U-phase first flat portion 6311u and the V-phase terminal flat portion 631v. Hereinafter, the direction in which the W-phase first flat portion 6311w extends is referred to as an extension direction of the W-phase terminal body portion 63w.

The W-phase busbar-side bent portion 632w is a portion bent in a direction perpendicular to the W-phase second flat portion 6312w from the first side of the W-phase second flat portion 6312w in the axial direction on the first side in the axial direction. The W-phase power-supply-source-side bent portion 633w is a portion bent in a direction perpendicular to the W-phase first flat portion 6311w from one end in the width direction of the W-phase first flat portion 6311w on the second side in the axial direction.

The W-phase busbar-side connection portion 64w extends in the thickness direction of the W-phase terminal body portion 63w from the W-phase busbar-side bent portion 632w and is connected to the W-phase connection end portion 58w of the W-phase busbar 51w. The W-phase power-supply-source-side connection portion 65w extends in the thickness direction of the W-phase terminal body portion 63w from the W-phase power-supply-source-side bent portion 633w and is connected to the power supply source.

In the U-phase terminal body portion 63u, a conduction path through which a current flows between the U-phase busbar-side connection portion 64u and the U-phase power-supply-source-side connection portion 65u includes a path extending in the width direction of the U-phase second flat portion 6312u and a path extending in the extension direction of the U-phase first flat portion 6311u. In the V-phase terminal body portion 63v, a conduction path through which a current flows between the V-phase busbar-side connection portion 64v and the V-phase power-supply-source-side connection portion 65v includes a conduction path extending in the extension direction of the V-phase terminal flat portion 631v. In the W-phase terminal body portion 63w, a conduction path through which a current flows between the W-phase busbar-side connection portion 64w and the W-phase power-supply-source-side connection portion 65w includes a path extending in the width direction of the W-phase second flat portion 6312w and a path extending in the extension direction of the W-phase first flat portion 6311w. The conduction path means a path through which a current flows.

The length of the U-phase first flat portion 6311u in the extension direction is longer than the length of the V-phase terminal flat portion 631v in the extension direction. The length of the V-phase terminal flat portion 631v in the extension direction is longer than the length of the W-phase first flat portion 6311w in the extension direction. The length of the U-phase second flat portion 6312u in the width direction is substantially the same as the length of the W-phase second flat portion 6312w in the width direction.

Therefore, in terminal body portions 63 of three phases, the length of the conduction path through which a current flows between a busbar-side connection portion 64 and a power-supply-source-side connection portion 65 is longer in the U-phase terminal body portion 63u than in the V-phase terminal body portion 63v and the W-phase terminal body portion 63w.

As illustrated in FIG. 6, in the external terminals 61 of three phases, the U-phase terminal body portion 63u, the V-phase terminal body portion 63v, and the W-phase terminal body portion 63w are overlapped in the thickness direction in a state where the positions of respective busbar-side bent portions 632 in the axial direction are the same.

As described above, on the first side of the terminal body portions 63 of three phases in the axial direction, the U-phase second flat portion 6312u is located on the first side in the width direction with respect to the V-phase terminal flat portion 631v, and the W-phase second flat portion 6312w is located on the side opposite to the side on which the U-phase second flat portion 6312u is located with respect to the V-phase terminal flat portion 631v. Therefore, the U-phase busbar-side connection portion 64u, the V-phase busbar-side connection portion 64v, and the W-phase busbar-side connection portion 64w extending in the thickness direction of the terminal body portions 63 of three phases are arranged in a direction perpendicular to the axial direction without overlapping each other when viewed in the axial direction.

In the terminal body portions 63 of three phases, the U-phase first flat portion 6311u, the V-phase terminal flat portion 631v, and the W-phase first flat portion 6311w have different lengths in the extension direction as described above. Therefore, the positions of the tips of the terminal body portions 63 of three phases on the second side in the axial direction are different from each other. Accordingly, the U-phase power-supply-source-side connection portion 65u, the V-phase power-supply-source-side connection portion 65v, and the W-phase power-supply-source-side connection portion 65w located at the ends of the terminal body portions 63 of three phases on the second side are arranged in the axial direction without overlapping each other when viewed in the radial direction.

Specifically, in the present embodiment, the busbar-side connection portions 64 of three phases are arranged in the order of the U-phase, the V-phase, and the W-phase in a direction perpendicular to the axial direction. The terminal body portions 63 of three phases are overlapped in the order of the W-phase, the V-phase, and the U-phase from outside to inside in the radial direction. The power-supply-source-side connection portions 65 of three phases are arranged in the order of the U-phase, the V-phase, and the W-phase from the second side to the first side in the axial direction.

The arrangement order of the power-supply-source-side connection portions 65 of three phases in the axial direction is determined by the lengths of the terminal body portions 63 of three phases extending from the busbar-side connection portions 64 of three phases in the extension direction. That is, in the present embodiment, the lengths of the terminal body portions 63 of three phases in the extension direction become shorter in the order of the U-phase, the V-phase, and the W-phase. Therefore, the power-supply-source-side connection portions 65 of three phases are arranged in the order of the U-phase, the V-phase, and the W-phase from the second side to the first side in the axial direction.

Accordingly, the arrangement order of the power-supply-source-side connection portions 65 of three phases in the axial direction can be changed by changing the lengths of the terminal body portions 63 of three phases in the extension direction. For example, if the lengths of the terminal body portions 63 of three phases in the extension direction are set to become smaller in the order of the W-phase, the V-phase, and the U-phase, the power-supply-source-side connection portions 65 of three phases can be arranged in the order of the W-phase, the V-phase, and the U-phase from the second side to the first side in the axial direction. In this case, in the terminal body portions 63 of three phases, the length of the conduction path through which a current flows between the busbar-side connection portion 64 and the power-supply-source-side connection portion 65 is longer in the W-phase terminal body portion 63w than in the U-phase terminal body portion 63u and the V-phase terminal body portion 63v.

As described above, the busbar-side connection portions 64 of the external terminals 61 of three phases are arranged in one direction, and the power-supply-source-side connection portions 65 of the external terminals 61 of three phases are arranged in a direction different from the direction in which the busbar-side connection portions 64 of the external terminals 61 of three phases are arranged. In the present embodiment, the arrangement direction of the busbar-side connection portions 64 of the external terminals 61 of three phases and the arrangement direction of the power-supply-source-side connection portions 65 of the external terminals 61 of three phases are perpendicular to each other.

Accordingly, even when the output positions of the respective phases of the power supply source are switched, the output terminals of the respective phases of the power supply source can be easily connected to the power-supply-source-side connection portions 65 by changing the external terminals 61 of three phases and changing the arrangement of the power-supply-source-side connection portions 65 of the multiple external terminals 61. In addition, since the power-supply-source-side connection portions 65 of the external terminals 61 of three phases are arranged in a direction different from the direction in which the busbar-side connection portions 64 of the external terminals 61 of three phases are arranged, the multiple external terminals 61 can be arranged compactly. Therefore, the compact busbar unit 50 can be obtained.

In addition, in the external terminals 61 of three phases, the U-phase terminal body portion 63u, the V-phase terminal body portion 63v, and the W-phase terminal body portion 63w are flat plates, and partially overlap each other in the thickness direction. As a result, the external terminals 61 of three phases can be arranged compactly, so that the busbar unit 50 can be made compact.

In the present embodiment, the power-supply-source-side connection portions 65 extend in the thickness direction of the terminal body portions 63. However, the power-supply-source-side connection portions may extend in the width direction of the terminal body portions.

As shown in FIGS. 5 and 6, the external terminals 61 of three phases are molded with resin in a state of being overlapped in the thickness direction. In the present specification, a resin portion covering the external terminals 61 of three phases is referred to as the external terminal holder 62.

The external terminal holder 62 extends in the axial direction of the stator core 21. An end of the external terminal holder 62 on the first side in the axial direction is located on the first side in the axial direction with respect to ends of the external terminals 61 of three phases on the first side in the axial direction, and has a recess 62a recessed toward the second side in the axial direction. With this configuration, the tips of the busbar-side connection portions 64 of three phases are positioned in the recess 62a without being covered with the external terminal holder 62.

The external terminal holder 62 is connected to the busbar holder 52. In the recess 62a, the busbar-side connection portions 64 of the external terminals 61 of the respective phases are connected to connection end portions 58 of the busbars 51 of the respective phases by welding or the like. The recess 62a is molded with resin in a state where the external terminal holder 62 and the busbar holder 52 are connected and the busbar-side connection portions 64 and the connection end portions 58 are connected. The resin is, for example, an epoxy resin.

The power-supply-source-side connection portions 65 of three phases are exposed so as to be contactable with the outside in a state where the external terminals 61 of three phases are covered with the external terminal holder 62. When the power supply source (not illustrated) is electrically connected to the power-supply-source-side connection portion 65 of each phase, power is supplied to the coil 26 of each phase via the external terminal 61 and the busbar 51 of each phase.

As described above, the busbar unit 50 according to the present embodiment includes the multi-phase busbars 51 connected to the multi-phase coils 26 wound around the stator core 21, and the multiple external terminals 61 that are members different from the multi-phase busbars 51, the multiple external terminals 61 being connected to the multi-phase busbars 51 and electrically connected to the power supply source. Each of the multiple external terminals 61 includes the terminal body portion 63, the busbar-side connection portion 64 located at one end of the terminal body portion 63 and connected to a busbar of one phase from among the multi-phase busbars 51, and the power-supply-source-side connection portion 65 located at another end of the terminal body portion 63 and electrically connected to the power supply source. At least two external terminals among the multiple external terminals 61 are different in length of a conduction path through which a current flows between the busbar-side connection portion 64 and the power-supply-source-side connection portion 65 in the terminal body portion 63.

With the configuration described above, the positions of the power-supply-source-side connection portions 65 of the multiple external terminals 61 can be changed by changing the multiple external terminals 61 connected to the multi-phase busbars 51. As a result, the connection positions between the multiple external terminals 61 and the output terminals of the respective phases of the power supply source can be changed without changing the arrangement of the busbars 51 connected to the coils 26 of the stator 2. Thus, even when the arrangement of the output terminals of the respective phases of the power supply source varies, the coils 26 of the motor 1 and the power supply source can be electrically connected without changing the configuration of the motor 1.

Specifically, in the busbar unit 50 according to the present embodiment, the terminal body portion 63 of each of the multiple external terminals 61 includes the busbar-side bent portion 632 that is positioned between the busbar-side connection portion 64 and the power-supply-source-side connection portion 65 and is bent in the thickness direction, and a terminal flat portion 631 extending from the busbar-side bent portion 632 in the thickness direction of the busbar-side connection portion 64. The power-supply-source-side connection portions 65 of the multiple external terminals 61 extend in the thickness direction of the terminal flat portions 631 at different positions in the terminal flat portions 631 in the extension direction.

Thus, even when the arrangement of the output terminals of the respective phases of the power supply source varies, the coils 26 of the motor 1 and the power supply source can be electrically connected without changing the configuration of the motor 1 by changing the lengths of the terminal flat portions 631 of the terminal body portions 63 of the multiple external terminals 61 in the extension direction.

In the present embodiment, the multi-phase busbars 51 and the multiple external terminals 61 are molded with resin. Thus, the busbars 51 and the external terminals 61 can be prevented from being deteriorated due to oxidation or the like.

In the present embodiment, the connection portions between the multiple busbars 51 and the busbar-side connection portions 64 of the multiple external terminals 61 are molded with resin. This makes it possible to prevent the connection portions between the busbars 51 and the external terminals 61 from being deteriorated due to oxidation or the like.

The stator 2 according to the present embodiment includes the busbar unit 50, the stator core 21, and the multi-phase coils 26 which are wound around the stator core 21 and connected to the multi-phase busbars 51 of the busbar unit 50. As a result, the stator 2 including the busbar unit 50 having the abovementioned configuration can be obtained.

Next, a method for manufacturing the busbar unit 50 having the abovementioned configuration will be described. The method for manufacturing the busbar unit 50 includes a busbar arrangement step, an external terminal arrangement step, an external terminal molding step, a connection step, and a connection portion molding step.

In the busbar arrangement step, the four busbar body portions 53u, 53v, 53w, and 53n covered with the busbar holder 52 are disposed on the outer peripheral side in the radial direction of the coil end portion 40 of the stator core 21 around which the three-phase coils 26u, 26v, and 26w are wound. As a result, the external terminal connection portions 55u, 55v, and 55w of three phases covered with the busbar holder 52 extend outward in the radial direction. The tips of the connection end portions 58u, 58v, and 58w of three phases respectively positioned at the tips of the external terminal connection portions 55u, 55v, and 55w of three phases protrude outward in the radial direction from the busbar holder 52.

In the external terminal arrangement step, the external terminals 61u, 61v, and 61w of three phases suitable for the arrangement order of the output terminals of the power supply source are prepared, and the external terminals 61u, 61v, and 61w of three phases are arranged such that the terminal body portions 63u, 63v, and 63w are located at the same position on the first side in the axial direction, and the terminal flat portions 631u, 631v, and 631w are overlapped in the thickness direction.

In the external terminal molding step, the external terminals 61u, 61v, and 61w of three phases are molded with resin while overlapping each other. The external terminal holder 62, which is a resin portion covering the external terminals 61u, 61v, and 61w of three phases, has the recess 62a from which the tips of the busbar-side connection portions 64 are exposed at the end on the first side in the axial direction. Therefore, the tips of the busbar-side connection portions 64u, 64v, and 64w of the external terminals 61u, 61v, and 61w of three phases covered with the external terminal holder 62 are exposed without being covered with the resin.

Next, in the connection step, the external terminal holder 62 and the busbar holder 52 are connected. With this step, in the recess 62a, the tips of the busbar-side connection portions 64u, 64v, and 64w of the external terminals 61u, 61v, and 61w of three phases and the tips of the connection end portions 58u, 58v, and 58w of the busbars 51u, 51v, and 51w of three phases are in contact with each other. In this state, the tips of the busbar-side connection portions 64u, 64v, and 64w of the external terminals 61u, 61v, and 61w of three phases and the tips of the connection end portions 58u, 58v, and 58w of the busbars 51u, 51v, and 51w of three phases are connected by welding or the like.

Lastly, in the connection portion molding step, the inside of the recess 62a is molded with resin in a state where the busbar-side connection portions 64u, 64v, and 64w and the connection end portions 58u, 58v, and 58w are connected in the recess 62a.

That is, the method for manufacturing the busbar unit 50 according to the present embodiment is a method for manufacturing the busbar unit 50 which includes: the multi-phase busbars 51 respectively connected to the multi-phase coils 26 arranged in the stator core 21; and the multiple external terminals 61 respectively connected to the multi-phase busbars 51 and electrically connected to the power supply source. The multiple external terminals 61 include at least two external terminals 61 that are different in length of a conduction path through which a current flows between the busbar-side connection portion 64 connected to the busbar 51 of one phase among the multi-phase busbars 51 and the power-supply-source-side connection portion 65 electrically connected to the power supply source.

The method for manufacturing the busbar unit 50 includes: the terminal molding step for molding the multiple external terminals 61 with resin and forming the recess in a side where the busbar-side connection portions 64 are located to expose the tips of the busbar-side connection portions 64; the connection step for connecting the multi-phase busbars 51 to the busbar-side connection portions 64 of the multiple external terminals 61 in the recess 62a; and the connection portion molding step for molding the inside of the recess 62a with resin while the busbar-side connection portions 64 are located in the recess 62a.

Through the above steps, the busbar unit 50 having the abovementioned structure can be obtained. In addition, since the connection portions between the busbars 51 and the external terminals 61 are molded with resin, it is possible to prevent the connection portions from being deteriorated due to oxidation or the like.

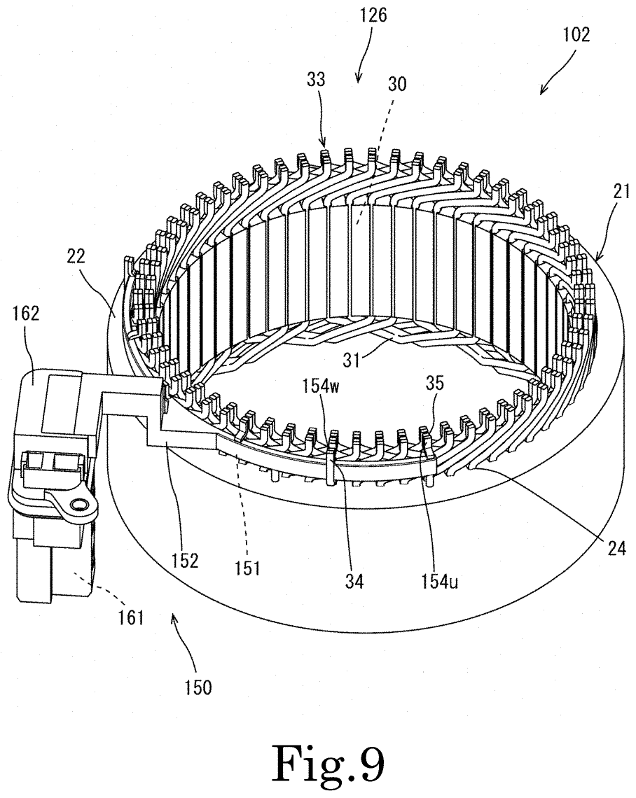

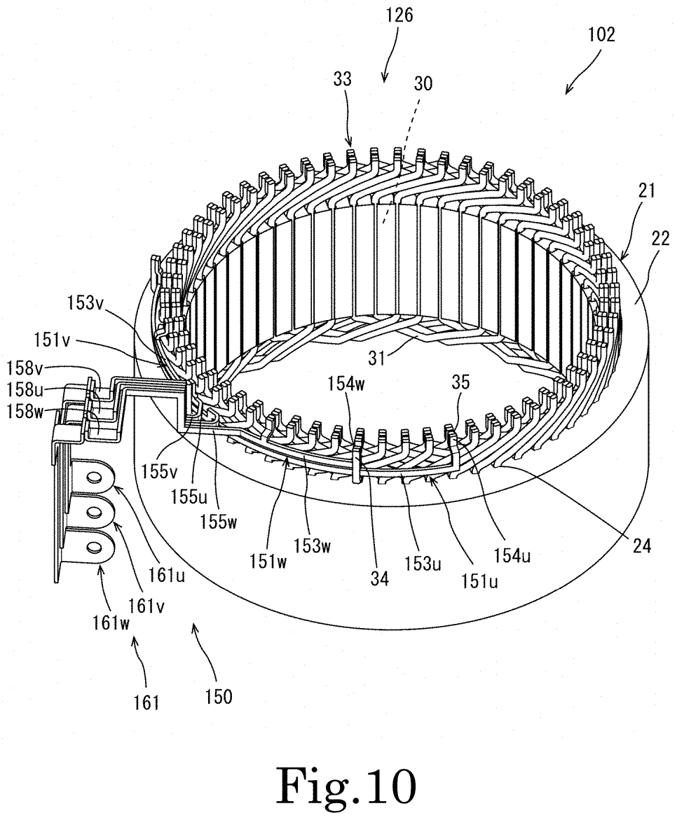

FIGS. 9 and 10 illustrate a schematic configuration of a stator 102 of a motor according to a second embodiment. The motor according to the second embodiment is different from the motor 1 according to the first embodiment in the method of connecting coils 126 by busbars 151. In addition, the configuration of external terminals 161 is different from the configuration of the external terminals 61 in the first embodiment. In the following, the same components as those in the first embodiment will be designated by the same reference numerals and the description thereof will be omitted. Only the parts different from those in the first embodiment will be described. FIG. 9 is a perspective view of the stator 102. FIG. 10 is a diagram illustrating a state in which a busbar holder 152 and an external terminal holder 162 of a busbar unit 150 are removed from the stator 102 illustrated in FIG. 9.

The stator 102 includes a stator core 21, the coils 126, and the busbar unit 150.

The coils 126 include a U-phase coil 126u, a V-phase coil 126v, and a W-phase coil 126w. The U-phase coil 126u, the V-phase coil 126v, and the W-phase coil 126w are wound around a plurality of teeth 23 of the stator core 21 in distributed winding, and are A-connected by the busbars 151 of the busbar unit 150. The winding of the U-phase coil 126u, the V-phase coil 126v, and the W-phase coil 126w with respect to the stator core 21 is similar to that in the first embodiment.

In each of the U-phase coil 126u, the V-phase coil 126v, and the W-phase coil 126w, a plurality of segment coils 27 is connected in series. The configuration of the segment coils is similar to that in the first embodiment, and thus, the description thereof will be omitted.

As in the first embodiment, the first coil end 34 and the second coil end 35 of each of the U-phase coil 126u, the V-phase coil 126v, and the W-phase coil 126w extend from the slot accommodation portions 30 located on the radially outermost side of the slots 24 and protrude to the first side in the axial direction of the stator core 21. In the present embodiment, the U-phase coil 126u, the V-phase coil 126v, and the W-phase coil 126w each include one first coil end 34 and one second coil end 35.

As illustrated in FIG. 9, the busbar unit 150 includes the busbars 151, the busbar holder 152, the external terminals 161, and the external terminal holder 162.

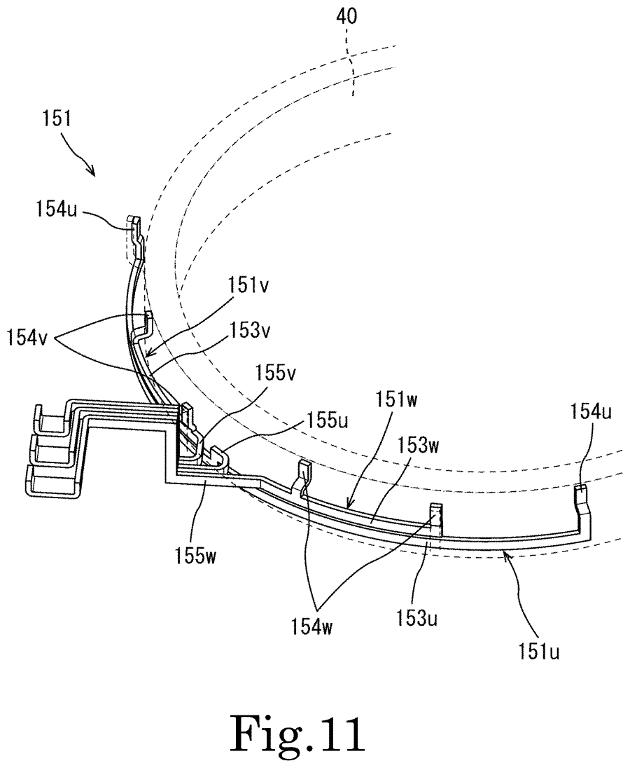

As illustrated in FIGS. 10 and 11, the busbars 151 include a U-phase busbar 151u, a V-phase busbar 151v, and a W-phase busbar 151w. Each of the U-phase busbar 151u, the V-phase busbar 151v, and the W-phase busbar 151w is a plate-like member. The thickness direction of each of the U-phase busbar 151u, the V-phase busbar 151v, and the W-phase busbar 151w coincides with the radial direction of the stator core 21.

The U-phase busbar 151u includes a U-phase busbar body portion 153u, two U-phase busbar connection portions 154u, and a U-phase external terminal connection portion 155u. The U-phase busbar body portion 153u, the two U-phase busbar connection portions 154u, and the U-phase external terminal connection portion 155u are integrally formed as a single member.

The V-phase busbar 151v includes a V-phase busbar body portion 153v, two V-phase busbar connection portions 154v, and a V-phase external terminal connection portion 155v. The V-phase busbar body portion 153v, the two V-phase busbar connection portions 154v, and the V-phase external terminal connection portion 155v are integrally formed as a single member.

The W-phase busbar 151w includes a W-phase busbar body portion 153w, two W-phase busbar connection portions 154w, and a W-phase external terminal connection portion 155w. The W-phase busbar body portion 153w, the two W-phase busbar connection portions 154w, and the W-phase external terminal connection portion 155w are integrally formed as a single member.

Each of the U-phase busbar body portion 153u, the V-phase busbar body portion 153v, and the W-phase busbar body portion 153w has an arc shape along the outer periphery of a coil end portion 40 when viewed in the axial direction. Each of the U-phase busbar body portion 153u, the V-phase busbar body portion 153v, and the W-phase busbar body portion 153w is positioned to overlap the first coil end 34 of the coil 126 of each phase when viewed in the radial direction of the stator core 21, and extends in the circumferential direction of the stator core 21.

Specifically, the U-phase busbar body portion 153u is positioned to overlap the first coil end 34 of the U-phase coil 126u and the second coil end 35 of the W-phase coil 126w when viewed in the radial direction of the stator core 21, and extends in the circumferential direction of the stator core 21. The U-phase busbar body portion 153u is longer in the circumferential direction than the V-phase busbar body portion 153v and the W-phase busbar body portion 153w. That is, both ends of the U-phase busbar body portion 153u in the circumferential direction are located at positions distant from both ends of the V-phase busbar body portion 153v in the circumferential direction and from both ends of the W-phase busbar body portion 153w in the circumferential direction.

The V-phase busbar body portion 153v is positioned to overlap the first coil end 34 of the V-phase coil 126v and the second coil end 35 of the U-phase coil 126u when viewed in the radial direction of the stator core 21, and extends in the circumferential direction of the stator core 21.

The W-phase busbar body portion 153w is positioned to overlap the first coil end 34 of the W-phase coil 126w and the second coil end 35 of the V-phase coil 126v when viewed in the radial direction of the stator core 21, and extends in the circumferential direction of the stator core 21.

The U-phase external terminal connection portion 155u extends outward from a position other than both ends of the U-phase busbar body portion 153u in the radial direction. The V-phase external terminal connection portion 155v extends outward from one end of the V-phase busbar body portion 153v in the radial direction. The W-phase external terminal connection portion 155w extends outward from one end of the W-phase busbar body portion 153w in the radial direction.

The U-phase external terminal connection portion 155u, the V-phase external terminal connection portion 155v, and the W-phase external terminal connection portion 155w respectively have a U-phase connection end portion 158u, a V-phase connection end portion 158v, and a W-phase connection end portion 158w which are located at the tips on the outside in the radial direction and connected to the external terminals 161.

The configurations of the U-phase external terminal connection portion 155u, the V-phase external terminal connection portion 155v, and the W-phase external terminal connection portion 155w are similar to those in the first embodiment except that extension portions are bent in the axial direction of the stator core 21. Therefore, the detailed description of the U-phase external terminal connection portion 155u, the V-phase external terminal connection portion 155v, and the W-phase external terminal connection portion 155w will be omitted.

The two U-phase busbar connection portions 154u extend to the first side in the axial direction of the stator core 21 from both ends of the U-phase busbar body portion 153u, and are connected to the first coil end 34 of the U-phase coil 126u and the second coil end 35 of the W-phase coil 126w.

The two V-phase busbar connection portions 154v extend to the first side in the axial direction of the stator core 21 from both ends of the V-phase busbar body portion 153v, and are connected to the first coil end 34 of the V-phase coil 126v and the second coil end 35 of the U-phase coil 126u.

The two W-phase busbar connection portions 154w extend to the first side in the axial direction of the stator core 21 from both ends of the W-phase busbar body portion 153w, and are connected to the first coil end 34 of the W-phase coil 126w and the second coil end 35 of the V-phase coil 126v.

The U-phase busbar 151u, the V-phase busbar 151v, and the W-phase busbar 151w are positioned on the outer peripheral side of the coil end portion 40 in the radial direction in a state of partially overlapping with each other in the radial direction or the axial direction.

FIG. 11 illustrates an example of the arrangement of the U-phase busbar 151u, the V-phase busbar 151v, and the W-phase busbar 151w with respect to the coil end portion 40.

As illustrated in FIG. 11, the U-phase external terminal connection portion 155u, the V-phase external terminal connection portion 155v, and the W-phase external terminal connection portion 155w partially overlap each other in the thickness direction.

The W-phase busbar body portion 153w of the W-phase busbar 151w is located on the first side in the circumferential direction with respect to the U-phase external terminal connection portion 155u of the U-phase busbar 151u. The V-phase busbar body portion 153v of the V-phase busbar 151v is located on the second side in the circumferential direction with respect to the U-phase external terminal connection portion 155u of the U-phase busbar 151u. The V-phase external terminal connection portion 155v and the W-phase external terminal connection portion 155w are arranged in the circumferential direction across the U-phase external terminal connection portion 155u.

A part of the U-phase busbar body portion 153u of the U-phase busbar 151u overlaps the W-phase busbar body portion 153w of the W-phase busbar 151w and the V-phase busbar body portion 153v of the V-phase busbar 151v when viewed in the axial direction.

In the present embodiment, the U-phase coil 126u, the V-phase coil 126v, and the W-phase coil 126w are A-connected by the U-phase busbar 151u, the V-phase busbar 151v, and the W-phase busbar 151w.

Specifically, the first coil end 34 of the U-phase coil 126u is connected to the U-phase busbar connection portion 154u of the U-phase busbar 151u. The first coil end 34 of the V-phase coil 126v is connected to the V-phase busbar connection portion 154v of the V-phase busbar 151v. The first coil end 34 of the W-phase coil 126w is connected to the W-phase busbar connection portion 154w of the W-phase busbar 151w.

The second coil end 35 of the U-phase coil 126u is connected to the V-phase busbar connection portion 154v of the V-phase busbar 151v. The second coil end 35 of the V-phase coil 126v is connected to the W-phase busbar connection portion 154w of the W-phase busbar 151w. The second coil end 35 of the W-phase coil 126w is connected to the U-phase busbar connection portion 154u of the U-phase busbar 151u.

As a result, the stator 102 can be obtained in which the U-phase coil 126u, the V-phase coil 126v, and the W-phase coil 126w wound around the stator core 21 are A-connected by the U-phase busbar 151u, the V-phase busbar 151v, and the W-phase busbar 151w.

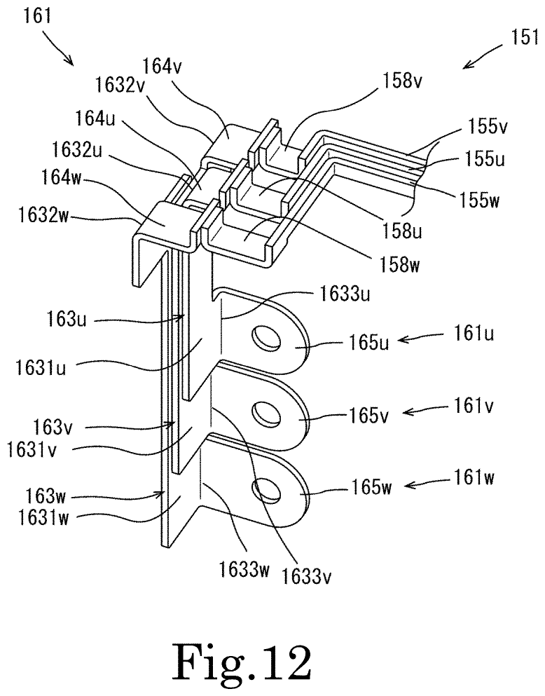

FIG. 12 is a perspective view of the external terminals 161 and connection portions between the external terminals 161 and the busbars 151 in the present embodiment. The external terminals 161 include a U-phase external terminal 161u, a V-phase external terminal 161v, and a W-phase external terminal 161w. The U-phase external terminal 161u, the V-phase external terminal 161v, and the W-phase external terminal 161w are plate-shaped members and molded with resin (see FIG. 9). In the present specification, a resin portion covering the external terminals 161 of three phases is referred to as the external terminal holder 162.

The U-phase external terminal 161u includes a U-phase terminal body portion 163u, a U-phase busbar-side connection portion 164u located at one end of the U-phase terminal body portion 163u, and a U-phase power-supply-source-side connection portion 165u located at another end of the U-phase terminal body portion 163u.

The U-phase terminal body portion 163u includes a U-phase terminal flat portion 1631u, a U-phase busbar-side bent portion 1632u, and a U-phase power-supply-source-side bent portion 1633u.

The V-phase external terminal 161v includes a V-phase terminal body portion 163v, a V-phase busbar-side connection portion 164v located at one end of the V-phase terminal body portion 163v, and a V-phase power-supply-source-side connection portion 165v located at another end of the V-phase terminal body portion 163v.

The V-phase terminal body portion 163v includes a V-phase terminal flat portion 1631v, a V-phase busbar-side bent portion 1632v, and a V-phase power-supply-source-side bent portion 1633v.

The W-phase external terminal 161w includes a W-phase terminal body portion 163w, a W-phase busbar-side connection portion 164w located at one end of the W-phase terminal body portion 163w, and a W-phase power-supply-source-side connection portion 165w located at another end of the W-phase terminal body portion 163w.

The W-phase terminal body portion 163w includes a W-phase terminal flat portion 1631w, a W-phase busbar-side bent portion 1632w, and a W-phase power-supply-source-side bent portion 1633w.

In the present embodiment, the U-phase terminal flat portion 1631u of the U-phase terminal body portion 163u does not extend in the width direction on the first side in the axial direction. The V-phase terminal flat portion 1631v of the V-phase terminal body portion 163v extends to the first side in the width direction on the first side in the axial direction. The W-phase terminal flat portion 1631w of the W-phase terminal body portion 163w extends to the side opposite to the side where the V-phase terminal flat portion 1631v extends on the first side in the axial direction. In the present embodiment, the lengths of the U-phase terminal body portion 163u, the V-phase terminal body portion 163v, and the W-phase terminal body portion 163w in the extension direction become longer in the order of the U-phase, the V-phase, and the W-phase.

The configurations of the U-phase external terminal 161u, the V-phase external terminal 161v, and the W-phase external terminal 161w other than the above configuration are similar to those of the first embodiment. Therefore, the detailed description of the U-phase external terminal 161u, the V-phase external terminal 161v, and the W-phase external terminal 161w will be omitted.

As described above, in the present embodiment, in terminal body portions 163 of three phases, the length of the conduction path through which a current flows between a busbar-side connection portion 164 and a power-supply-source-side connection portion 165 is longer in the V-phase terminal body portion 163v than in the U-phase terminal body portion 163u and longer in the W-phase terminal body portion 163w than in the V-phase terminal body portion 163v. Therefore, in the present embodiment, at least two external terminals among the three external terminals 161 are also different in length of the conduction path through which a current flows between the busbar-side connection portion 164 and the power-supply-source-side connection portion 165 in the terminal body portions 163 of three phases.

As illustrated in FIG. 12, in the external terminals 161 of three phases, the U-phase terminal body portion 163u, the V-phase terminal body portion 163v, and the W-phase terminal body portion 163w are overlapped in the thickness direction in a state where the positions of respective busbar-side bent portions 1632 in the axial direction are the same.

On the first side of the terminal body portions 163 of three phases in the axial direction, the U-phase busbar-side connection portion 164u, the V-phase busbar-side connection portion 164v, and the W-phase busbar-side connection portion 164w are arranged in a direction perpendicular to the axial direction without overlapping each other when viewed in the axial direction, as in the first embodiment.

On the second side of the terminal body portions 163 of three phases in the axial direction, the U-phase power-supply-source-side connection portion 165u, the V-phase power-supply-source-side connection portion 165v, and the W-phase power-supply-source-side connection portion 165w are arranged in the axial direction without overlapping each other when viewed in the radial direction, as in the first embodiment.

Specifically, in the present embodiment, the busbar-side connection portions 164 of three phases are arranged in the order of the V-phase, the U-phase, and the W-phase in the direction perpendicular to the axial direction. The terminal body portions 163 of three phases are overlapped in the order of the U-phase, the V-phase, and the W-phase from inside to outside in the radial direction. Power-supply-source-side connection portions 65 of three phases are arranged in the order of the U-phase, the V-phase, and the W-phase from the first side to the second side in the axial direction.

In the present embodiment, the arrangement order of the power-supply-source-side connection portions 165 of three phases in the axial direction is also determined by the lengths of the terminal body portions 163 of three phases extending from the busbar-side connection portions 164 of three phases in the extension direction. That is, in the present embodiment, the lengths of the terminal body portions 163 in the extension direction become longer in the order of the U-phase, the V-phase, and the W-phase. Therefore, the power-supply-source-side connection portions 165 of three phases are arranged in the order of the U-phase, the V-phase, and the W-phase from the first side to the second side in the axial direction.

Accordingly, in the present embodiment, the arrangement order of the power-supply-source-side connection portions 165 of three phases in the axial direction can also be changed by changing the lengths of the terminal body portions 163 of three phases in the extension direction.

As described above, in the present embodiment, the positions of the power-supply-source-side connection portions 165 of the external terminals 161 of three phases can be changed by changing the external terminals 161 of three phases connected to the busbars 151 of three phases. As a result, the connection positions between the multiple external terminals 161 and the output terminals of the respective phases of the power supply source can be changed without changing the arrangement of the busbars 151 connected to the coils 126 of the stator 102. Thus, even when the arrangement of the output terminals of the respective phases of the power supply source varies, the coils 126 of the motor and the power supply source can be electrically connected without changing the configuration of the motor.

While the embodiments of the present invention have been described above, the above embodiments are merely examples for implementing the present invention. Thus, the present invention is not limited to the embodiments described above, and the embodiments described above may be appropriately modified and implemented without departing from the scope of the present invention.

In the first and second embodiments, the coils 26, 126 include three-phase coils. However, the coils may include multi-phase coils other than three-phase coils.

In the first embodiment, the coils 26 include two sets of three-phase coils. However, the coils may include one set or three or more sets of three-phase coils.

In the second embodiment, the coils 126 include one set of three-phase coils. However, the coils may include two or more sets of three-phase coils.

In the first and second embodiments, all the second coil connection portions 33 are located on the first side in the axial direction with respect to the stator core 21, and all the first coil connection portions 31 are located on the second side in the axial direction with respect to the stator core 21. However, all the second coil connection portions may be located on the second side in the axial direction with respect to the stator core. All the first coil connection portions may be located on the first side in the axial direction with respect to the stator core. A part of the second coil connection portions may be located on the first side in the axial direction with respect to the stator core. A part of the first coil connection portions may be located on the second side in the axial direction with respect to the stator core. A part of the second coil connection portions may be located on the second side in the axial direction with respect to the end of the stator core. A part of the first coil connection portions may be located on the first side in the axial direction with respect to the stator core.

In the first and second embodiments, the first coil ends 34 and the second coil ends 35 are located on the side where the second coil connection portions 33 are located in the axial direction with respect to the stator core 21. However, the first coil ends may be located on either the first side or the second side in the axial direction with respect to the stator core. In addition, the second coil ends may be located on either the first side or the second side in the axial direction with respect to the stator core.

In the first and second embodiments described above, the lengths of the terminal flat portions 631, 1631 of three phases in the extension direction are different from each other, and the power-supply-source-side connection portions 65, 165 of the respective phases extend in the thickness direction of the terminal flat portions 631, 1631 of the respective phases at the ends of the terminal flat portions 631, 1631. However, the lengths of the terminal flat portions of three phases in the extension direction may not be different from each other, and it is only sufficient that the power-supply-source-side connection portions of the respective phases extend in the thickness direction of the terminal body portions of the respective phases at different positions of the terminal body portions in the extension direction.

In the first and second embodiments, the stator core 21 has a cylindrical shape. However, the stator core may have a shape other than the cylindrical shape as long as the stator core is tubular.

In the first and second embodiments, the motor 1 is a so-called inner rotor type motor in which the rotor 3 is located so as to be rotatable about the central axis P in the tubular stator 2. However, the motor may be a so-called outer rotor type motor in which a stator is located in a tubular rotor.

The present invention can be used for a stator that electrically connects a coil having high rigidity and an external device using a busbar.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A busbar unit comprising:
multi-phase busbars connected to multi-phase coils wound around a stator core; and
multiple terminals that are members different from the multi-phase busbars, the multiple terminals being connected to the multi-phase busbars and electrically connected to a power supply source, wherein
each of the multiple terminals includes
a terminal body portion,
a busbar-side connection portion located at one end of the terminal body portion and connected to a busbar of one phase from among the multi-phase busbars, and a power-supply-source-side connection portion located at another end of the terminal body portion and electrically connected to the power supply source, and
at least two terminals among the multiple terminals are different in length of a conduction path through which a current flows between the busbar-side connection portion and the power-supply-source-side connection portion in the terminal body portion.

2. The busbar unit according to claim 1, wherein
the multi-phase busbars are molded with resin, and the multiple terminals are molded with resin.

3. The busbar unit according to claim 1, wherein
the busbar-side connection portions of the multiple terminals are arranged in one direction, and
the power-supply-source-side connection portions of the multiple terminals are arranged in a direction different from the direction in which the busbar-side connection portions of the multiple terminals are arranged.

4. The busbar unit according to claim 1, wherein
the direction in which the busbar-side connection portions of the multiple terminals are arranged is perpendicular to the direction in which the power-supply-source-side connection portions of the multiple terminals are arranged.

5. The busbar unit according to claim 1, wherein
connection portions between the multi-phase busbars and the busbar-side connection portions of the multiple terminals are molded with resin.

6. The busbar unit according to claim 1, wherein
the terminal body portions of the multiple terminals are each a flat plate, and partially overlap each other in a thickness direction.

7. The busbar unit according to claim 6, wherein
the terminal body portion of each of the multiple terminals includes
a bent portion located between the busbar-side connection portion and the power-supply-source-side connection portion and bent in a thickness direction, and
a flat portion extending in a thickness direction of the busbar-side connection portion from the bent portion, and
the power-supply-source-side connection portions of the multiple terminals extend in a thickness direction of the flat portions at different positions of the flat portions in an extension direction.

8. The busbar unit according to claim 1, wherein
the coils connected to the busbars are formed from a rectangular wire.

9. A stator comprising:
the busbar unit according to claim 1;
the stator core; and
multi-phase coils wound around the stator core and connected to the multi-phase busbars of the busbar unit.

10. A method for manufacturing a busbar unit that includes multi-phase busbars respectively connected to multi-phase coils wound around a stator core, and multiple terminals respectively connected to the multi-phase busbars and electrically connected to a power supply source,
the multiple terminals including at least two terminals that are different in length of a conduction path through which a current flows between a busbar-side connection portion connected to a busbar of one phase among the multi-phase busbars and a power-supply-source-side connection portion electrically connected to the power supply source, the method comprising:
a terminal molding step for molding the multiple terminals with resin and forming a recess in a side where the busbar-side connection portions are located to expose tips of the busbar-side connection portions;
a connection step for connecting the multi-phase busbars to the busbar-side connection portions of the multiple terminals in the recess; and
a connection portion molding step for molding the inside of the recess with resin while the busbar-side connection portions are located in the recess.
